(19) United States
(12) Patent Application Publication
(10) Pub. No.: US 2010/0180714 A1
(43) Pub. Date: Jul. 22, 2010

(54) LEVER WITH INTERMEDIATE FULCRUM

(76) Inventor: Guido Valentini, Milano (IT)

Correspondence Address: J. Rodman Steele;Novak Druce & Quigg LLP, 525 Okeechobee Blvd, Suite 1500, West Palm Beach, FL, 33401, US

(21) Appl. No.: 12/689,966

(22) Filed: Jan. 19, 2010

(30) Foreign Application Priority Data
Jan. 20, 2009 (IT) MI2009U000015

(51) Int. Cl. G05G 1/04

(52) U.S. Cl. 74/522

(57) ABSTRACT

A lever (2) is disclosed that is rotatably mounted on the upper part of a manually manoeuvrable machine (1) for machining surfaces, that provides the rotation fulcrum (3) interposed between the head (20) of the supporting lever (2) of the front part of the palm of the hand (30) of the operator, and the tail (21) of the thrust lever (2) of the rear part of the palm of the hand (30) of the operator (FIG. 1).

The present invention relates to a lever with intermediate fulcrum.

Machines are known for machining surfaces, for example sanding machines, lapping machines and polishing machines, comprising a driving lever that is rotatably mounted on the upper part of the machine.

Said machines are moved manually, and the lever is mounted such that the operator gripping the head of the machine controls the lever by rotating the lever around the fulcrum of the lever.

The lever is usually mounted on the upper part of the machine, with the fulcrum at the rear end of the lever: the operator gripping the machine rotates the lever, activating the machine.

The lever is driven by overcoming the return force of a spring mounted at a driving pivot on which the lower part of the lever acts.

Continuous use of the machine may cause fatigue to the operator.

Also the continuous alternation of activating and deactivating the machine compromises the physical wellbeing of the operator and therefore the durability of the quality of the machining.

On the other hand, it is necessary to mount a return spring with a certain force intensity to enable effective control of the driving: a spring with weak force intensity would make it difficult to combine the gripping action of the machine with the driving action.

Disadvantageously, simply gripping the head of the machine would always activate the machine.

The object of the invention is to make a lever with a rotating fulcrum for a machine for machining surfaces that limits operator fatigue during work without compromising the control of the driving of the lever.

According to the invention this object is achieved by a lever rotatably mounted on the upper part of a machine for machining surfaces that is manually manoeuvrable, characterised in that it provides the rotation fulcrum interposed between the head of the supporting lever of the front part of the palm of the hand of the operator, and the tail of the thrust lever of the rear part of the palm of the hand of the operator.

These and other features of the invention will be made clearer from the following detailed description of a practical embodiment thereof illustrated by way of non-limiting example in the attached drawings, in which:

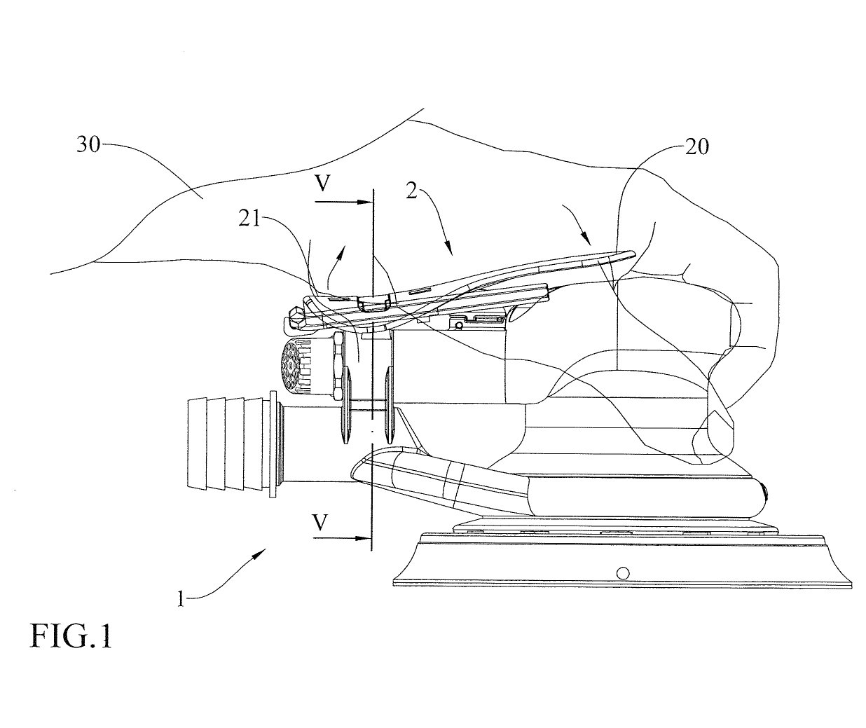

FIG. 1 shows a side view of a sanding machine with lever according to the invention;

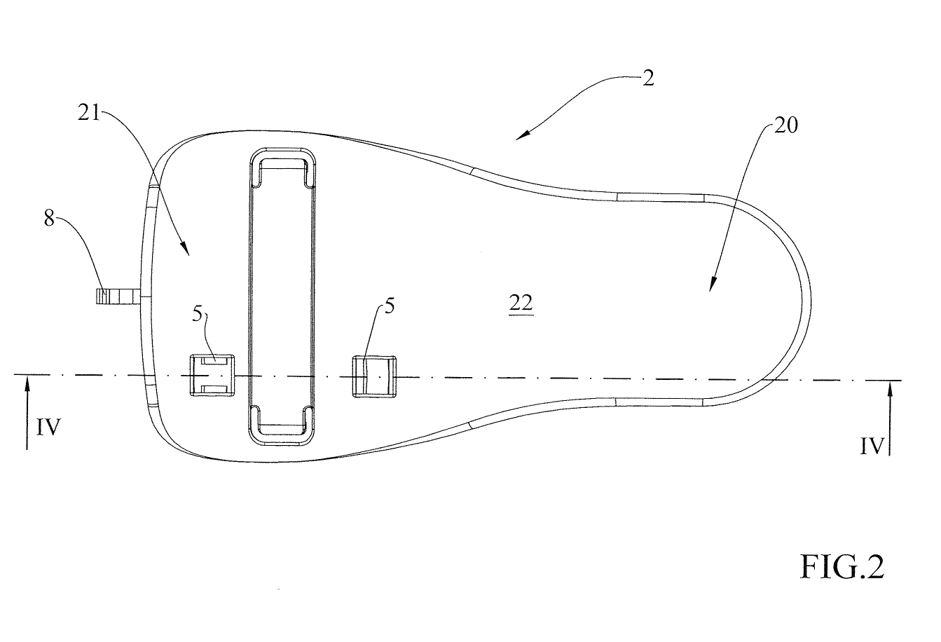

FIG. 2 shows a top plan view of the lever;

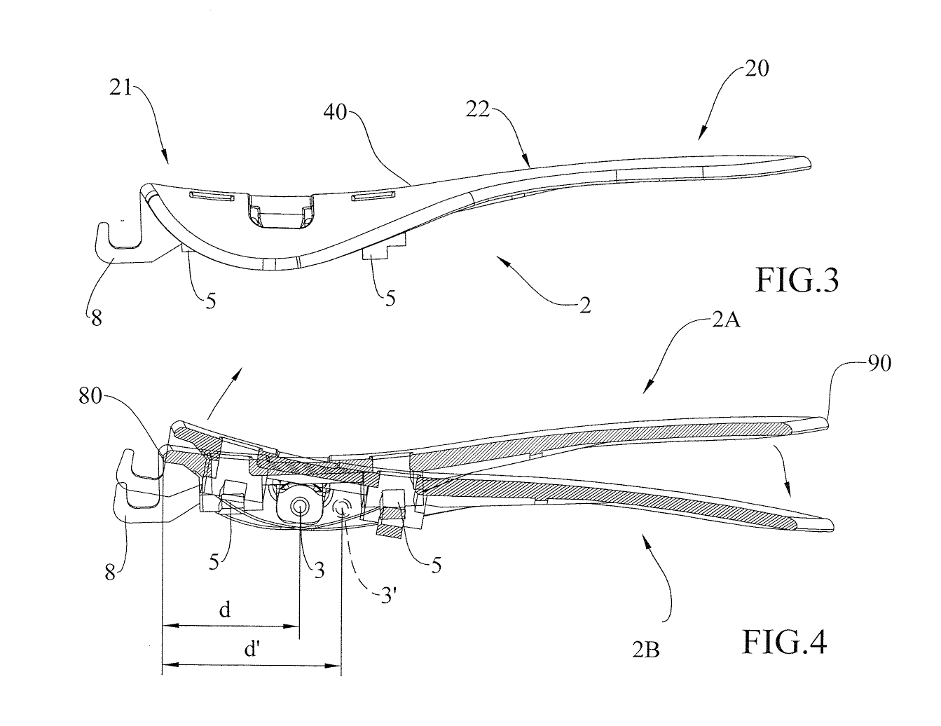

FIG. 3 shows a side view of the lever;

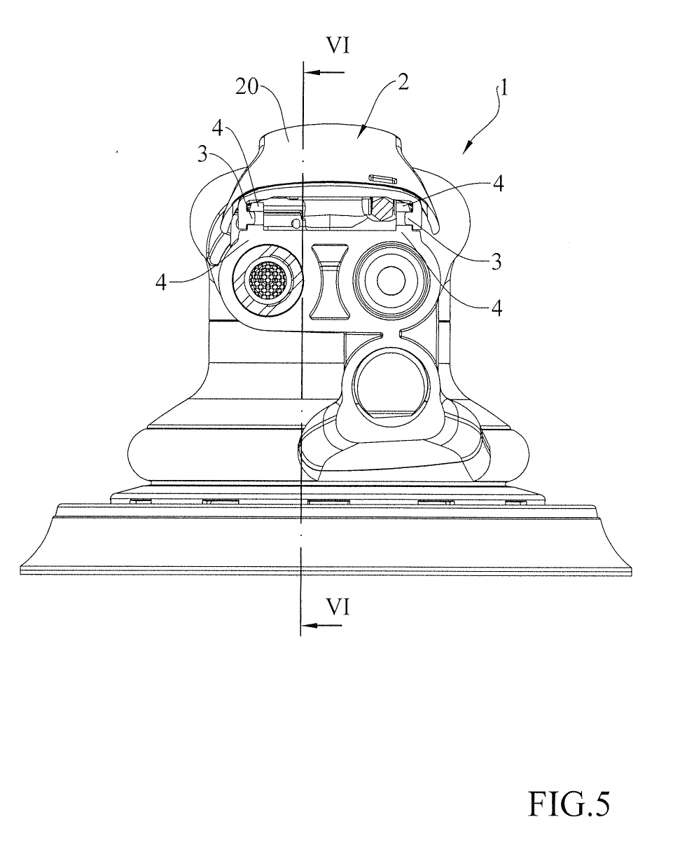

FIG. 4 shows a section view according to the line IV-IV in FIG. 2;

FIG. 5 shows a section view according to the line V-V in FIG. 1;

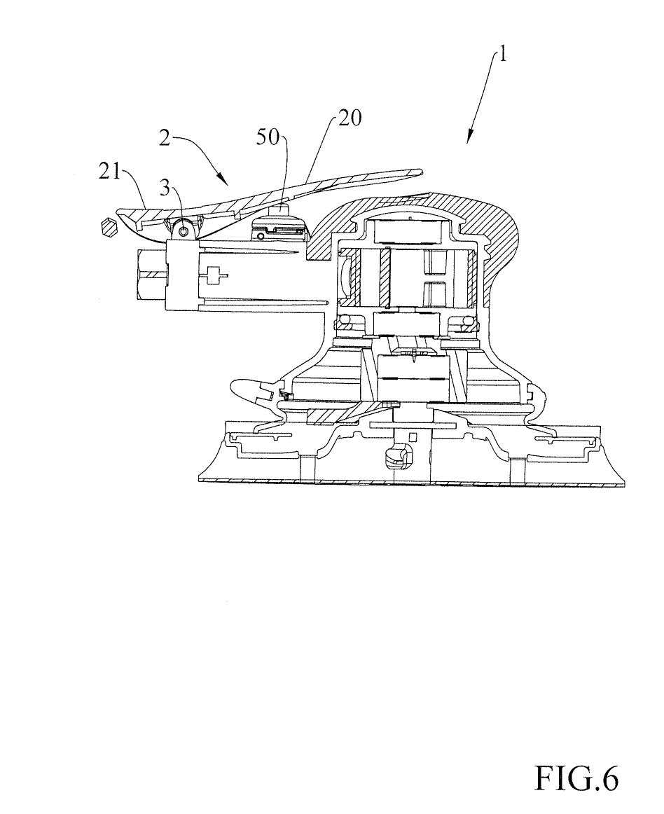

FIG. 6 shows a section view according to the line VI-VI in FIG. 5.

A polishing machine 1 (FIGS. 1 and 5) comprises a control lever 2 rotatably connected by pivots or fulcrums 3 to the frame 4 of said machine 1.

As can be seen from FIGS. 3-4, the lever 2 has the rotating fulcrum 3 in an intermediate zone with respect to the total length of the lever 2, of which a front or head portion 20 for supporting the front part of the palm of the hand 30 of the operator, and a rear or tail thrust portion 21 of the rear part of the palm can be consequently distinguished.

It should be noted that in FIG. 1 a left hand is shown that grips the machine; nevertheless the invention remains new and inventive also for gripping with the right hand.

In FIG. 4 there is shown the lever 2 in the two positions, the rest position 2A and the work position 2B, the fulcrum 3 coinciding.

In FIG. 6 there is shown a vertically sliding driving pivot 50 that is controlled by the lever 2. The pivot 50 internally comprises a spring that is not shown that opposes the driving by the lever 2, and which enables the pivot 50 to return to the rest position with the machine not active.

The upper surface 22 of the lever 2 is shaped so as to promote the combined and simultaneous support and thrust action (see non-numbered arrows in the figures), i.e. the front portion 20 is convex to couple better with the front part of the palm of the hand 30, the rear portion 21 near the wrist of the palm of the hand 30 is concave to “push” the front portion 20 better.

The fulcrum 3 remains moved towards the tail 21, which is thus much shorter than the head 20 according, for example, to proportions that are deducible from FIG. 3 (the tail 21 is less than a third of the head 20). This choice is dictated by the need to maintain the head 20 of the lever substantially above the head of the machine to facilitate the grip of the operator and the simultaneous driving of the pivot 50, which, as shown by FIG. 6, is placed below the head 20 of the lever 2. Further, the portion of the palm of the hand 30 pressing on the head 20 of the lever 2 is much greater than the rear part of the palm.

More in general, in order to ensure the desired thrust effect of the tail 21 on the palm of the hand 30, the end 80 of the tail 21 has to be at least at a distance of d=8 mm from the fulcrum 3. A shorter distance does not allow the concave surface of the tail 21 to “embrace” effectively the rear part of the palm to ensure optimum thrust.

Varying the positioning of the fulcrum 3 with respect to the tail 21 and the head 20 determines a different thrust effect and thus a different force of the hand and consequently of the arm of the operator. Different machines may entail different optimum ergonomics determined by a different distance between the fulcrum 3, the end 80 of the tail 21 and the end 90 of the head 20 (distance d′ in FIG. 4 in which the fulcrum 3′ is shown moved by a few mm to the right to increase the thrust surface of the tail 21).

The concave surface of the tail 21 continues beyond the fulcrum 3 for a length that is substantially similar to that of the tail 21, there then being a concavity change (geometrical “inflexion point” 40) from which the convex surface of the head 20 of the lever 2 starts. The pivot 50 is substantially placed at the inflexion point 40 to facilitate the operating thereof and for constructional reasons.

The upper surface 22 of the lever 2 is thus ergonomic, the line and proportions of which having been studied to adapt better to the shape of the palm of the hand 30 of the operator.

This invention thus enables operator fatigue to be limited by combining said supporting actions and thrust of the palm of the hand 30, and controlling better the driving of the pivot 50 in consideration of different forces (support and thrust) on different parts of the palm of the hand (portion near the fingers and portion near the wrist). The operator is able to “feel” easily the forces in play and modulate the pressure to be exerted on the lever 2.

Further, the lever 2 provides a pair of supports or consecutive cylindrical housings 5 into which an L-shaped Allen key 6 is insertable, in particular the longer shaft 7 of the L.

The lever 2 further comprises frontally a further housing 8 (FIGS. 4, 5) on which the short arm 9 of the Allen key 6 is supportable, the long shaft 7 being rotatable inside the supports 5.

1. Lever (2) rotatably mounted on the upper part of a manually manoeuvrable machine (1) for machining surfaces, wherein said lever provides the rotation fulcrum (3) interposed between the head (20) of the supporting lever (2) of the front part of the palm of the hand (30) of the operator, and the tail (21) of the thrust lever (2) of the rear part of the palm of the hand (30) of the operator.

2. Lever (2) according to claim 1, wherein the end (80) of the tail (21) is placed at a variable distance (d) of at least 8 mm from the fulcrum (3).

3. Lever (2) according to claim 1, characterised in that wherein the upper supporting surface of the palm of the hand (30) of the head (20) is convex, and the upper surface of the tail (21) is concave.

4. Lever (2) according to claim 3, wherein the concavity of the tail (21) extends beyond the fulcrum (3) of the lever (2), an inflexion point (40) determining the concavity change to the convex head (20) of the lever (2).

5. Machine (1) for machining surfaces, wherein a lever (2) is provided according to claim 1.
